(19) United States
(12) Patent Application Publication
(10) Pub. No.: US 2017/0220972 A1
(43) Pub. Date: Aug. 3, 2017

(54) EVALUATION SYSTEM AND METHOD

(71) Applicant: BUGWOLF PTY LTD, Victoria (AU)

(72) Inventor: Ashley CONWAY, Victoria (AU)

(73) Assignee: BUGWOLF PTY LTD, Victoria (AU)

(21) Appl. No.: 15/125,955

(22) PCT Filed: Mar. 13, 2015
(86) PCT No.: PCT/AU2015/050106

§ 371 Date: Sep. 13, 2016

(30) Foreign Application Priority Data
Mar. 13, 2014 (AU) 2014900865

(51) Int. Cl. G06Q 10/06; G01D 21/00

(52) U.S. Cl. CPC G06Q 10/06398; G01D 21/00

(57) ABSTRACT

The present disclosure relates to a system and method for identifying faults in a product or service. A processor receives a request comprising characterising data for identifying faults. The processor then selects multiple tester identifiers based on performance data associated with each of the multiple tester identifiers and based on the characterising data to generate a team record. After that, the processor generates a user interface associated with each of the multiple tester identifiers of the team record. The user interface comprises a user control element allowing a tester to provide a fault description. Through this user interface the processor receives multiple fault records that each comprises the fault description and are associated with one of the multiple tester identifiers of the team record. Finally, the processor stores each of the multiple fault records associated with the product or service and the associated tester identifier on a data store.

### TECHNICAL FIELD

The present disclosure relates to a system and method for identifying faults in a product or service.

### BACKGROUND

In modem society, there is becoming an increasing reliance upon electronic devices and software programs to perform a variety of tasks and everyday functions. Most individuals in developed countries own at least one electronic device for this purpose, with many households having more than one device, such as personal computers, mobile telephones and the like.

In order to perform such a variety of tasks, most computer devices are configured to contain and run a variety of software programs. Computer software is typically developed by programmers and software designers who may be employed by large multi-national companies through to small independent businesses or individuals skilled in a specific software code or language. Irrespective of the manner in which a software application is developed, an important step in developing a software application is to ensure that any faults or errors present within the software are identified and repaired prior to release of the software application for use by the general public. Thus, it is often important for programmers and software developers to have skills in not only developing and designing software to perform one or more tasks, but to also identify any faults or errors within the software program and to correct such errors, which may prevent the software from performing its intended task or posing as a security threat.

In many larger corporations, the task of “debugging” or reviewing the software for faults, errors, or usability problems may be performed by a dedicated team of testers, designers, product experts, and or programmers focused on performing this task. There are also companies specifically established for performing this function, which many smaller companies or individuals may employ prior to releasing the software. Irrespective of the specific manner in which this service may be sourced, there is generally a lack of transparency in relation to reviewing and analysing the specific skill set of the individuals responsible for performing this task to ensure that the best possible individuals are employed. Further, as the skills required to identify and solve bugs in software are constantly changing and developing, there is limited opportunity to constantly assess and review debugging skills within a team environment. Thus there is a need to provide a system and method for evaluating and quantifying a skill set of individuals responsible for testing software applications that provides an updated analysis of the individual's ability to perform the task.

Further, in recent times, the concept of companies or business having a contingent workforce has developed in popularity as a means for individuals/businesses to take advantage of a wide pool of talent to perform tasks, particularly relating to software development and design. However, whilst a contingent workforce has been successful in some areas of software design, many highly skilled individuals may not participate in such contingent workforce arrangements due to the large number of individuals participating and the reduced likelihood of obtaining a valuable payment for their services, due to the large number of participants competing for payment from a prize pool.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY

A computer implemented method for identifying faults in a product or service comprises:
receiving a request for identifying faults in the product or service, the request comprising characterising data that characterises the request;
selecting multiple tester identifiers based on performance data associated with each of the multiple tester identifiers and based on the characterising data to generate a team record, each tester identifier being associated with a tester;
generating a user interface associated with each of the multiple tester identifiers of the team record, the user interface comprising a user control element allowing a tester to provide a fault description;
receiving through the user interface multiple fault records, each of the multiple fault records comprising the fault description and being associated with one of the multiple tester identifiers of the team record; and
storing each of the multiple fault records associated with the product or service and the associated tester identifier on a data store.

Since the team record is created based on the request characteristics, it is possible to build a team that best suits the particular request.

The product or service may be one or more of:
source code;
a financial report;
a technical specification;
user interface;
software application; and
a food item.

The method may further comprise determining a monetary value indicative of a monetary reward associated with each of the multiple tester identifiers based on the multiple fault records associated with that tester identifier. It is an advantage that each tester is rewarded for exactly those faults that the tester has identified.

Receiving the multiple fault records may comprise receiving a fault classification associated with each of the multiple fault records and determining the monetary value is based on the fault classification. It is an advantage that different classes of faults can lead to different monetary value and as a result, the testers are motivated to prioritise more severe faults that can lead to a higher monetary reward.

The characterising data may comprise an indication of the total funds available for testing the product and determining the monetary value is based on the total funds available. It is an advantage that the testers compete for a fixed price pool, that is, the total funds available. This way, the cost for the product developer is managed and the testers know upfront how high their earning potential is because they know the total cash pool amount which is up for grabs, of how many testers will share in that pool, depending on their performance.

The method may further comprise:
receiving input data indicative of a monetary value of each identified fault,
wherein determining the monetary value indicative of a monetary reward associated with each of the multiple tester identifiers comprises determining the monetary value indicative of a monetary reward associated with each of the multiple tester identifiers based on the monetary value of each identified fault.

It is an advantage that each tester is remunerated based on the value of each fault to the product developer.

The method may further comprise updating the performance data associated with one of the multiple tester identifiers based on the fault record associated with that one of the multiple tester identifiers.

Since the performance data is updated, the team selection is based on current and up to date information about the performance of each tester. As a result, a tester benefits in the future from his high performance as that tester is more likely to be selected in an elite team based on the tester's high reputation score, which also leads to possibly being considered for higher paying challenges.

The method may further comprise:
generating a user interface associated with each of the multiple tester identifiers, the user interface comprising a user control element allowing a tester to provide a fault description of an assessment product; and
determining the performance data by comparing the fault description to fault data stored on a data store associated with the assessment product.

The testers are assessed on products with known faults, that is, assessment products where the fault data is stored on a data store. The advantage is that all testers can be assessed on the same products and the result is objective. Clients may use pre-fabricated application to ask their testers and testers may pay a small fee and test a pre-fabricated application with embedded errors.

Receiving each of the multiple fault records may comprise receiving video data visualising that fault record. It is an advantage that videos of faults can be processed more efficiently and the faults can be fixed quicker and with fewer resources. Receiving each of the multiple fault records may comprise receiving audio data describing that fault record.

The method may further comprise generating a user interface comprising a graphical indication of the performance data associated with multiple tester identifiers. The graphical indication of the performance data may be a list of testers that is ordered by their respective performance.

It is an advantage that testers are motivated to increase their performance to be listed prominently as the highest performing tester. The experience for the tester is similar to playing a game, which makes participating in the testing more enjoyable and satisfying for the tester. This significantly improves the quality and the volume of work which is produced for clients and speeds up taking a better quality product to market. Also, because testers can choose which projects they want to work on, and when they want to work, they feel more empowered which produces a better output for our clients.

The graphical indication of the performance data may comprise an icon located in relation to one of the multiple tester identifiers and indicative of an achievement by that tester in identifying faults. The achievement may comprise a predetermined number of identified faults per predetermined time period.

The characterising data may comprises an indication of a performance threshold and selecting the multiple tester identifiers may comprise selecting the multiple tester identifiers such that the performance data associated with the multiple tester identifiers is greater or equal than the performance threshold.

It is an advantage that a product developer can specify the minimum standard of testers, such as Newbie, Adventurer, Explorer, and Elite, as a threshold. As a result, the testing service can be tailored more specifically to the needs of the product developer and the cost to the product developer can be adjusted accordingly.

Receiving the request may comprise receiving input data indicative of a period of time for identifying faults and indicative of total funds for identifying faults. It is an advantage that the period of time and the total funds can be provided to the testers and the testers can then decide in which testing job they wish to participate according the personal preferences and available time. By reducing the time frame in which they have to test (traditional crowdsourced and traditional manual exploratory testing tends to be dragged out over longer periods of time with many more testers) which increase the performance and their focus, which produces better results, and enables customers to ship their products faster to their customers, and in some cases generate revenue faster.

The method may further comprise operating a secure proxy server, wherein receiving the request comprises receiving the request through the secure proxy server and receiving the multiple fault records comprises receiving the multiple fault records through the secure proxy server.

Selecting multiple testers may comprise randomly adding tester identifiers associated with performance data below a performance threshold based on the characterising data to the team record.

Software, when executed by a computer, causes the computer to perform the above method.

A computer system for identifying faults in a product or service comprises:
an input port;
a processor to
   receive using the input port a request for identifying faults in the product or service, the request comprising characterising data that characterises the request,
   select multiple tester identifiers based on performance data associated with each of the multiple tester identifiers and based on the characterising data to generate a team record, each tester identifier being associated with a tester,
   generate a user interface associated with each of the multiple tester identifiers of the team record, the user interface comprising a user control element allowing a tester to provide a fault description, and
   receive using the input port through the user interface multiple fault records, each of the multiple fault records comprising the fault description and being associated with one of the multiple tester identifiers of the team record; and
a data store to store each of the multiple fault records associated with the product or service and the associated tester identifier.

A computer implemented method for reporting faults in a product or service comprises:
receiving a stream of video data representing interaction of a tester with the product or service;
recording the stream of video data on a data store;
displaying a user interface to the tester, the user interface comprising a first user control element allowing the tester to provide a fault description and a second user control element allowing the tester to set a start time of a segment of the recorded video data such that the segment represents interaction of the tester with the product or service while the tester identifies the fault;
receiving through the user interface the fault description and the start time; and
sending the fault description and the start time associated with the product or service and associated with the tester identifier to a testing server.

Receiving the stream of video data may comprise receiving the stream of video data from a separate computer device. Receiving the stream of video data may comprise receiving a sequence of mirrored screen images as the stream of video data. Receiving the stream of video data may comprise receiving the stream of video data over a Wifi or Bluetooth data connection.

The method may further comprise receiving a notification that the tester has identified a fault in the product or service and upon receiving the notification stopping the recording of the stream of video data on the data store until the fault description and the start time are received.

The user interface may further comprise a representation of a location of the fault within the product or service.

Software, when executed by a computer, causes the computer to perform the above method for reporting faults in a product or service.

A computer network for identifying faults in a product or service comprises:
a first computer system to test the product or service, the first computer system comprising an output port to send video data representing a mirrored screen of the first computer system;
a second computer system comprising:
   a first input port to receive from the first computer system a stream of video data representing interaction of a tester with the product or service;
   a data store to record the stream of video data;
   a display device to display a user interface to the tester, the user interface comprising a first user control element allowing the tester to provide a fault description and a second user control element allowing the tester to set a start time of a segment of the recorded video data such that the segment represents interaction of the tester with the product or service while the tester identifies the fault;
   a second input port to receive through the user interface the fault description and the start time; and
   an output port to send the fault description and the start time associated with the product or service and associated with the tester identifier to a testing server.

A method for determining an evaluation value indicative of an outcome of identifying faults in a product or service comprises:
receiving first input data indicative of a number of faults identified for each of multiple fault classifications;
receiving second input data indicative of a first cost for not identifying a fault of each of the multiple fault classifications;
receiving third input data indicative of a second total cost for identifying the faults in the product or service;
determining an output value indicative of the ratio between the first cost multiplied by the number of faults and the second cost; and
generating a user interface comprising an indication of the output value.

Software that, when executed by a computer, causes the computer to perform the above method for determining an evaluation value indicative of an outcome of identifying faults in a product or service.

A computer system for determining an evaluation value indicative of an outcome of identifying faults in a product or service comprises:
an input port to receive
   first input data indicative of a number of faults identified for each of multiple fault classifications;
   second input data indicative of a first cost for not identifying a fault of each of the multiple fault classifications;
   third input data indicative of a second total cost for identifying the faults in the product or service; and
a processor to
   determine an output value indicative of the ratio between the first cost multiplied by the number of faults and the second cost; and
   generate a user interface comprising an indication of the output value.

A computer implemented method for locating results comprises:
receiving a request for locating results, the request comprising characterising data that characterises the request;
selecting multiple searcher identifiers based on performance data associated with each of the multiple searcher identifiers and based on the characterising data to generate a team record, each searcher identifier being associated with a searcher;
generating a user interface associated with each of the multiple searcher identifiers of the team record, the user interface comprising a user control element allowing a searcher to provide a result description;
receiving through the user interface multiple result records, each of the multiple result records comprising the result description and being associated with one of the multiple searcher identifiers of the team record; and
storing each of the multiple result records the associated searcher identifier on a data store.

Software, when executed by a computer, causes the computer to perform the above method for locating results.

A computer system for locating results comprises:
an input port;
a processor to
   receive using the input port a request for locating results, the request comprising characterising data that characterises the request,
   select multiple searcher identifiers based on performance data associated with each of the multiple searcher identifiers and based on the characterising data to generate a team record, each searcher identifier being associated with a searcher,
   generate a user interface associated with each of the multiple searcher identifiers of the team record, the user interface comprising a user control element allowing a searcher to provide a result description, and
   receive using the input port through the user interface multiple result records, each of the multiple result records comprising the result description and being associated with one of the multiple searcher identifiers of the team record; and
a data store to store each of the multiple result records and the associated searcher identifier.

### BRIEF DESCRIPTION OF DRAWINGS

The invention may be better understood from the following non-limiting description of examples, in which:

FIG. 1 is a simplified block diagram of a system for identifying faults in a product or service;

FIG. 2 illustrates the host of FIG. 1 in more detail as computer system;

FIG. 3 is a flow chart depicting a method for assessing a software tester;

FIG. 4 illustrates step 36 of FIG. 3 in more detail;

FIG. 5 illustrates an example database for multiple testers;

FIG. 6 illustrates a user interface to allow a tester to submit a fault:

FIG. 7 illustrates a database for storing multiple fault records;

FIG. 8 is a flow chart depicting a method for locating faults/bugs in a software application:

FIG. 9 illustrates a user interface to assist the testing director;

FIG. 10 illustrates a computer implemented method as performed by the tester's computer for reporting faults in a product or service:

FIGS. 11a and 11b illustrate a user interface to generate a request for identifying faults;

FIG. 12 illustrates a return on investment model.

### DESCRIPTION OF EMBODIMENTS

Some features will now be described with particular reference to the accompanying drawings. However, it is to be understood that the features illustrated in and described with reference to the drawings are not to be construed as limiting on the scope of the invention.

A system and method for identifying faults in a product or service will be described below in relation to its application for use in measuring the ability of users to detect faults in software applications as well as identifying the presence of faults in software applications. However, it will be appreciated that the system and method of the present invention can equally be employed in testing the skills of users to find and identify faults or errors across a variety of disciplines, including technical specifications, accounting systems, such as financial reports, graphic or artistic fields as well as a means for identifying faults or errors in those disciplines. This may also include testing and quality assurance for financial audits, geo mapping, search results, online advertising and other areas, such as Hardware Products, Online Documentation and Scientific Research, Internet Search Results, Search Engine Optimisation, Wearable Technology, Internet Connected Cars, Internet of Things, wherever automating testing with computers is less accurate, and using humans is the best method of determining the quality of the product or service. Products can also include other products connected to the internet such as wearables technology, hardware, internet of things.

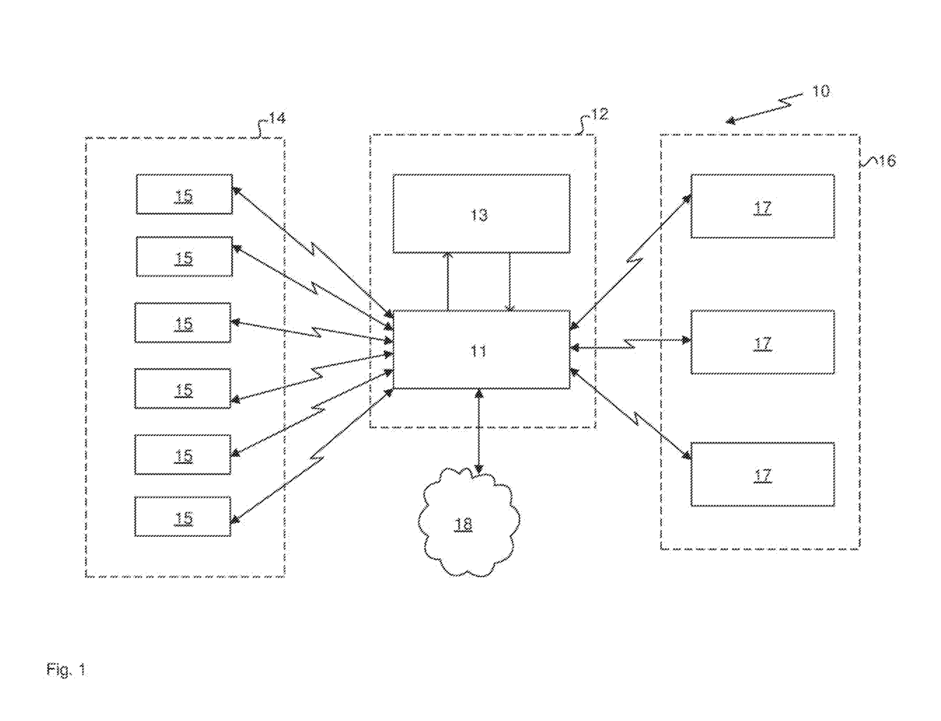

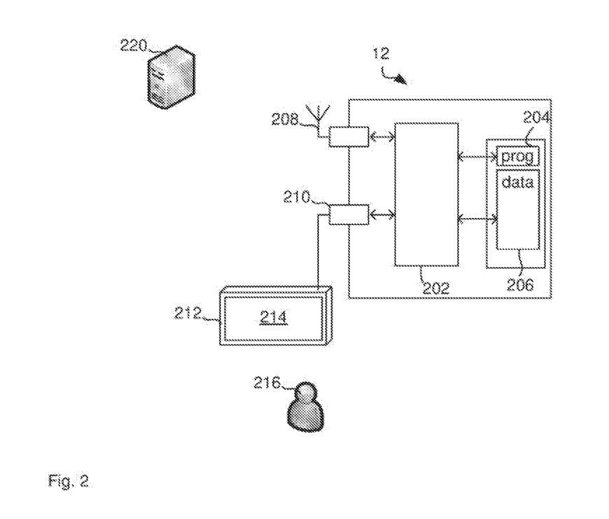

FIG. 1 illustrates a system 10 for identifying faults in a product or service. As depicted, the system 10 comprises a host depicted by dashed lines 12, and two user groups: a tester user group depicted as dashed line 14; and a client user group depicted as dashed line 16.

The host 12 generally comprises a remotely located storage medium 13 that houses one or more servers which are accessible via the host interface 11. The host interface 11 functions as a portal from which individual members of the tester user group 14 and/or the client user group 16 can access the system and any information stored on the servers 13. The manner in which data is transferred between the host interface 1 and the servers 13, and the host interface 11 and each of the individual members of user groups 14 and 16 is preferably through a distributed computing network via wired or wireless communication channels, as will be appreciated by those skilled in the art. In a preferred embodiment, the distributed computing network is the internet. It is noted that any step that is described herein to be performed by the host 12, the server 13 or the host interface 11 may equally be performed by other parts of system 10 or simply by any processor as described with reference to FIG. 2.

Each of the individual members of the user groups 14 and 16 are connected to the distributed computing network 14 by way of computer devices, such as personal computers, laptops, mobile phones and/or tablet devices. This could also include Google glasses, wearable technology, beacons, robots, virtual reality headsets and technology, 3D technology, sensors, embedded technology or connected cars and homes. In such an arrangement, individual members of the user groups 14 and 16 are able to independently access the relevant information stored the servers 13.

As will be appreciated, the servers 13 are configured to store and process information provided by each of the members of user groups 14 and 16 as well as to operate any programs on behalf of the host 12, as will be discussed in more detail below. The servers 13 may be any of a number of servers known to those skilled in the art and are intended to be operably connected to the interface 11 so as to operably link to each of the user groups 14 and 16. The servers 13 typically include a central processing unit or CPU that includes one or more microprocessors and memory operably connected to the CPU. The memory can include any combination of random access memory (RAM), a storage medium such as a magnetic hard disk drive(s) and the like.

The memory of the servers 13 may be used for storing an operating system, databases, software applications and the like for execution on the CPU. As will be discussed in more detail below, in a preferred embodiment, the database stores data relating to each individual member of the user groups 14 and 16 in a relational database, together with predetermined tests which are to be operated by the host 12 to assess the skills of the individual members of the tester user group 14.

In relation to the tester user group 14, this group typically includes individuals 15, typically programmers, and software designers and testers, who wish to register with the host 12 to take part in the system and method of the present invention. Each individual member 15 typically has a set of skills associated with software programming and in particular, identifying and correcting faults present within a software application.

Each individual 15 in the tester user group 14 will register with the host 12 via the host interface 11. This is typically achieved by the user utilising a computer, mobile phone or the like to access the host interface 11 and enter their details so as to register with the host 12. In order for the individual 15 to register as a member of the tester user group 14, the individual will be prompted to enter their name and any other relevant identification details, as well as contact details to enable the host 12 to contact the individual 15. Upon registration of these details, the host 12 will then assess the individual 15 to evaluate the skill set of that individual 15 in relation to various aspects of fault detection required by the host 12, in a manner as will be described below.

In one example, host 12 further receives an interview rating, endorsement or criminal check. Host 12 may further determine whether the individual 15 works for a competitor, such as by automatically scanning their social network pages and profiles such as LinkedIn, Facebook, or Twitter or other online profile pages.

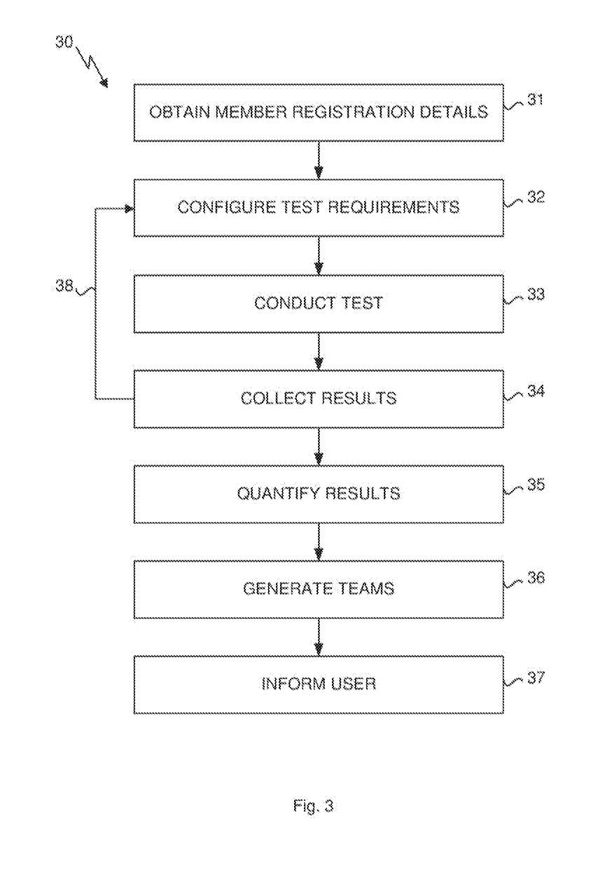

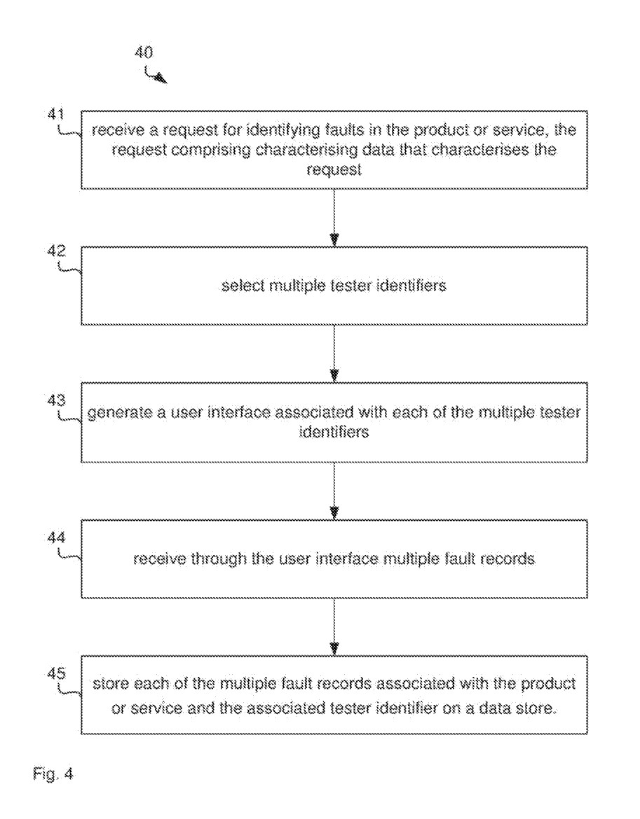

FIG. 2 illustrates host 12 in more detail as computer system 200. The computer system 200 comprises a processor 202 connected to a program memory 204, a data memory 206, a communication port 208 and a user port 210. The program memory 204 is a non-transitory computer readable medium, such as a hard drive, a solid state disk or CD-ROM. Software, that is, an executable program stored on program memory 204 causes the processor 202 to perform the methods in FIGS. 3 and 4, that is, processor 202 receives a request for identifying faults, selects testers, generates a user interface for each tester, receives fault descriptions through the user interface and stores the fault descriptions on data memory 206.

The processor 102 may receive data, such as fault records, from data memory 206 as well as from the communications port 208 and the user port 210, which is connected to a display 212 that shows a visual representation 214 of the testing process to a user 216, such as an administrator. In one example, the processor 202 receives a fault record from a device of a tester 220 via communications port 208, such as by using a Wi-Fi network according to IEEE 802.11. The Wi-Fi network may be a decentralised ad-hoc network, such that no dedicated management infrastructure, such as a router, is required or a centralised network with a router or access point managing the network.

In one example, the processor 202 receives and processes the fault record in real time. This means that the processor 202 determines a testing status, such as test coverage, every time a fault record is received from the tester's computer 220 and completes this calculation before the tester's computer 220 sends the next fault record.

Although communications port 208 and user port 210 are shown as distinct entities, it is to be understood that any kind of data port may be used to receive data, such as a network connection, a memory interface, a pin of the chip package of processor 202, or logical ports, such as IP sockets or parameters of functions stored on program memory 204 and executed by processor 202. These parameters may be stored on data memory 206 and may be handled by-value or by-reference, that is, as a pointer, in the source code.

The processor 202 may receive data through all these interfaces, which includes memory access of volatile memory, such as cache or RAM, or non-volatile memory, such as an optical disk drive, hard disk drive, storage server or cloud storage. The computer system 200 may further be implemented within a cloud computing environment, such as a managed group of interconnected servers hosting a dynamic number of virtual machines.

It is to be understood that any receiving step may be preceded by the processor 202 determining or computing the data that is later received. For example, the processor 202 constructs a fault record as a pre-processing step and stores the fault record in data memory 206, such as RAM or a processor register. The processor 202 then requests the data from the data memory 206, such as by providing a read signal together with a memory address. The data memory 206 provides the data as a voltage signal on a physical bit line and the processor 202 receives the fault record via a memory interface.

It is to be understood that throughout this disclosure unless stated otherwise, fault records, tester identifiers and the like refer to data structures, which are physically stored on data memory 106 or processed by processor 102. Further, for the sake of brevity when reference is made to particular variable names, such as “fault classification”, this is to be understood to refer to values of variables stored as physical data in computer system 10.

Referring to FIG. 3, the method 30 for assessing and processing an individual member 15 of the tester user group 14 is depicted.

Typically, the individual member 15 accesses the host interface 11 with an intention to register their details to be considered for any future projects being offered by the host 12. In step 21 the individual member 15 enters their personal details, such as: name, age, location, devices, technologies, sex and any relevant contact details which are stored in the server 13 of the host 12 as part of a pool of individual members 15. As the member 15 is registering with the host 12 so as to take part in any future projects being offered by the host, there is a potential that the member 15 may be able to earn financial rewards and non-financial rewards should they take part in any future projects. As such, the member may enter appropriate bank account details to receive any future payments as well as any work history or similar information deemed relevant by the host 12. In step 31 the user may nominate their expertise or preferred project parameters, based on their programming experience. The host 12 may also include a registration fee for processing and registering the details of the member, however the fee may be an optional requirement of step 21. Once the member has registered in step 31, their registration details will be recorded and a confirmation may be sent to the member 15 via their nominated contact details, typically their preferred email account. In one example, the host 12 requests members to complete a two factor authentication setup which sends a text message to the member's mobile device with a unique code and the member is asked to enter that code into the software upon registration and when signing in to confirm their online identity and to add an extra layer of security for clients.

In step 32, the host 12 determines what testing will be required for the member 15 in accordance with the information provided in step 31. As a default, each registered member will be required to undertake four specifically designed tests to assess four main skill sets required to detect faults in most software applications. Possible faults may include, but are not limited to, security vulnerabilities, database errors, general software bugs, broken links, slow loading components and timeouts, user interface design faults and other usability problems as well as payment processing faults and failures. These four tests may include:

1. Usability Test—where the member 15 is presented with a predetermined software module, such as a website, that has bugs or faults embedded therein relating to usability issues and is requested to identify as many of the usability focused bugs as possible within a given time;

2. Functionality Test—where the member 15 is presented with a predetermined software module, such as a website, that has bugs or faults embedded therein relating to functionality issues and is requested to identify as many of the functionality focused bugs as possible within a given time;

3. Security Test—where the member 15 is presented with a predetermined software module, such as a website, that has bugs or faults embedded therein relating to security issues and is requested to identify as many of the functionality focused bugs as possible within a given time; and

4. Combined Test—where the member 15 is presented with a predetermined software module, such as a website, that has bugs or faults embedded therein relating to a variety of issues and is requested to identify as many of the bugs as possible within a given time.

It will be appreciated that other tests may also be configured to test other skill sets as required. For example, if the member 15 was an expert accountant, a spreadsheet or financial report could be created with a range of embedded faults or bugs provided therein which may vary depending on their severity, to test the ability of the member 15 in their specific discipline. Thus, in step 32, the host may determine whether the registered member 15 has elected to take part in all tests or may assess the past history of the member 15 and configure the most relevant test required to be undertaken by the member.

In step 33, the host 12 conducts the appropriate test to be undertaken by the member 15, as discussed above. Access to the test may be obtained by the registered member 15 via the host interface 11 which may then direct the member 15 to the test which is located on the host server 13, or on a remotely hosted server 18, which may be cloud based. In any event, the member 15 will be provided with a security pass to access the specific test, typically consisting of a password, which will then establish a time frame for the member to complete the test, once commenced.

By way of example, the test is typically in the form of a website having 10 minor, 10 normal and 10 important bugs or faults embedded therein. The member is then required to find and identify as many of the bugs or faults in the least amount of time. Upon commencement of the test the member 15 is able to flag and identify tests within the website as they progress, with the information being captured in real time as the user undertakes the test. At the completion of the test, or at a point in which no further faults or bugs are being detected, the member 15 exits the test.

To facilitate repeatability of the tests, such that they can be taken numerous times by a member 15, the software application or website will have the capability of being either manually or algorithmically switchable between correct code or faulty code at any time and within any component of the software application. As such, the test system will have the ability to change data sets and change user interface elements randomly or periodically, to ensure that members cannot pre-determine where software faults might appear based on previous tests undertaken by that member.

To assist the member 15 undertaking the test, the test environment may include a map of the components to allow the member to see which areas of the test application they have already viewed and which areas of the application they haven't viewed. Such a map would also allow the member 15 to avoid covering areas of the test application they have already covered and focus on new areas of the test application that have not been covered. Such a map would also allow the host to access data showing which components of the test application are being detected the most and which are being detected the least. This data would enable the host to create future tests for specific areas of the application that have not been subject to extensive testing. The map of the components may be a heat map where the test coverage is indicated by different colours. In another example, processor 202 may generate a geographic map that indicates the density of testers in geographic locations or the number of faults identified by testers in geographic locations. The map may also comprise a pictorial view of the product.

In one example, in step 34, the results of the test are collected and collated by the host 12. Typically the results are points based, whereby in the test discussed above where there are 30 bugs (10 minor/10 normal/10 important); each bug identified carries a point loading, namely 1 point per minor bug, 2 points per normal bug and 3 points per important bug. The total points for that test will be collated for the member 15 together with the time taken to complete the test.

As depicted by arrow 38 in FIG. 2, upon completion of one test, the member 15 may then be required to complete all tests determined for completion by that member 15 in step 32. In the event that further tests are required, steps 33 and 34 will be repeated as discussed above.

In step 35, the results of the member's test are quantified by the host 12. An individual score for each test will be taken and stored against the registered members profile in the server 13, together with an overall score across each of the tests. The overall score may be an accumulated point score or an average point score across the tests. Each member 15 will then be ranked based on the individual test as well as the overall test and this ranking will be regularly updated as new members are registered and members complete new tests.

In step 36, the host 12 creates an elite team of members based on the scores for each test and for the overall scores. These elite teams may contain different members for each team depending upon the skill set tested and in one embodiment may comprise those individuals with scores in, for example, the top 75%. It will be appreciated that the criteria for selecting the team members may vary depending upon a variety of differing circumstances. The elite teams established in step 36 may comprise between 2, 5, 10, 30, 40 members, although the number of team members may vary depending on a variety of factors, such as availability of members as well as client requests and preferences for future projects. The team list will then be stored by the host 12 in the relevant server 12 which will provide an updated listing of the elite team members for any future projects that may be undertaken by the host 12. This may similarly apply to team lists of reputation scores, that is performance data, other than elite members, such as team lists of members with an explorer level.

FIG. 4 illustrates this step 36 in more detail as performed by processor 202 of host 12. Processor 202 receives 41 a request for identifying faults in the product or service. For example, a software developer wishes to have their software product tested and submits a test request on a website. Processor 202 receives the request over the internet, such as by using GET or POST methods. The request comprises characterising data that characterises the request, such as the minimum skill level of testers that the developer wishes to work on the testing and the total price for the testing task.

In another example, user 216 is a representative of the testing service provider and reaches an agreement with the developer in relation to the testing service. User 216 then receives all the data describing the testing by email, for example, and enters the data together with the agreed price into a user interface displayed on display 214. As a result, processor 202 receives the request and the characterising data directly from user 216.

Processor 202 then selects multiple tester identifiers based on performance data associated with each of the multiple tester identifiers and based on the characterising data to generate a team record.

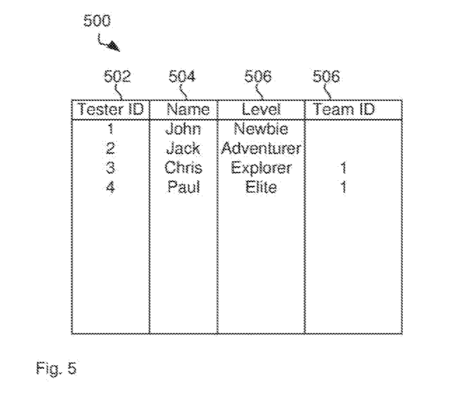

FIG. 5 illustrates an example database 500 for multiple testers. Each tester is associated with a tester identifier 502, a name 504 and performance data in the form of a skill level 506. In this example, the developer has provided characterising data that comprises an indication of a performance threshold. Processor 202 then selects the multiple tester identifiers such that the performance data 506 associated with the multiple tester identifiers 502 is greater or equal than the performance threshold. For example, the performance threshold may be “Explorer”, which means processor 202 selects identifiers “3” and “4”. As a result, processor 202 adds a team identifier 506 into database 500 in order to generate a team record, that is, the team record of team identifier “1” now includes tested identifiers “3” and “4” as shown in database 500.

Once the team is selected and the team records are generated and stored, processor 202 generates 43 a user interface associated with each of the multiple tester identifiers of the team record.

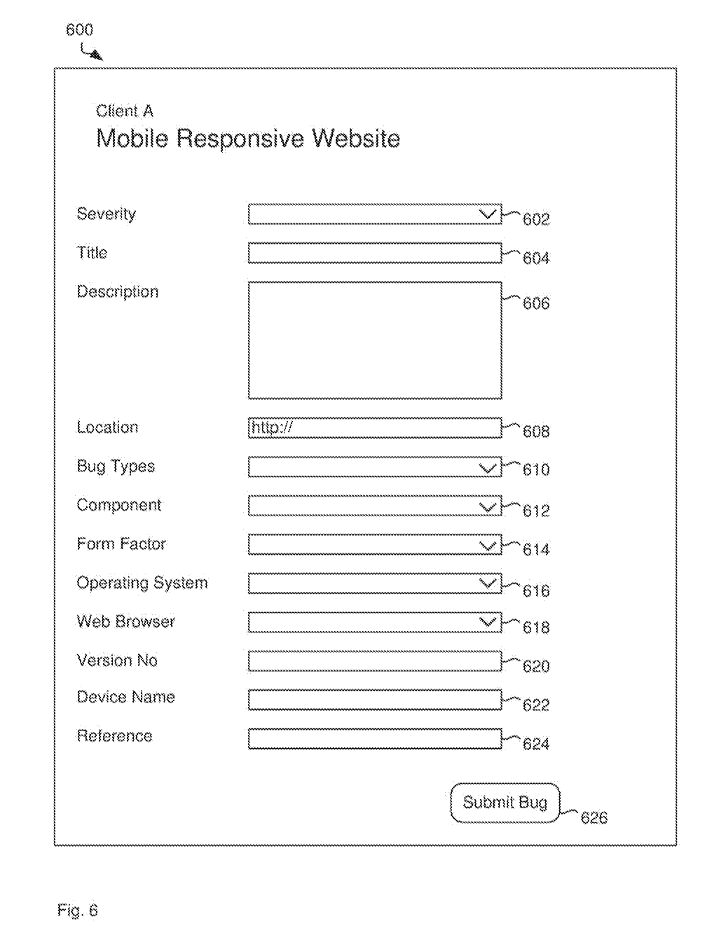

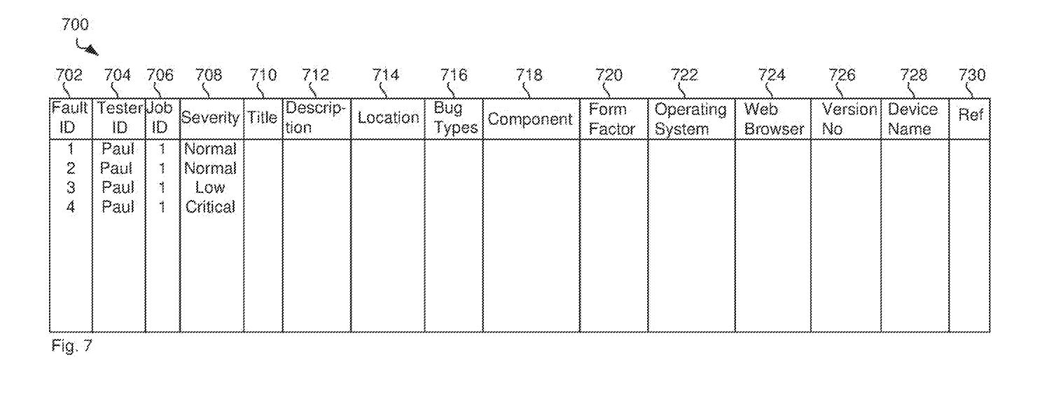

FIG. 6 illustrates a user interface 600 to allow a tester to submit a fault, such as a bug. In one example, the user interface 600 is an HTML website, that is, processor 202 generates HTML code, stores the HTML code as a file on a data store such that the tester can access the HTML file by directing a browser software to the respective URL. User interface 600 comprises a drop-down menu to specify the severity 602 of the bug. In one example, the options for severity are “low”. “normal”, “high” and “critical”. User interface 600 further comprises a text box for entering a title 604 and a text box for entering a description 606.

It is noted that particular types of user control elements, such as text boxes and drop down lists, are described but other types may equally be used. In particular, processor 202 may generate other types of user control elements allowing a tester to provide a fault description.

User interface 600 further comprises a text box for entering a location 608, such as a URL of a web-page that contains the identified fault including URL parameters. User interface 600 also comprises drop-down menus for bug types 610, component 612, form factor 614, web browser 618 and text boxes for entering a version number of the web browser 620, device name 622 and a reference 624. Bug types may include Accessibility, Content, Cross Browser, Experience, Functional, Usability. Performance, Security, Spelling, and Other. Components may include Apply, Contact Form, Footer. Header, Login, My Details, Navigation, Other, Search, Sign Up, Tracking and Watch List. Testers can choose more than one bug type and or component when submitting each bug report. These bug types may vary and may be customised each cycle (challenge) depending on the type of product and service that is to be tested. It is to be understood that the terms cycle, challenge, project and job are used as synonyms unless stated otherwise.

It is noted that any of the data provided by use of the various user control elements may be considered as a description by processor 202. For example, the location URL 608 alone may be sufficient as a description of the fault. In other examples, the description comprises a physical address, IP address, GPS location, or location or area within the graphic interface.

Since the tester is logged into the user interface 600, the identifier of that tester is available either at the client computer of the tester or the host 12. In one example, the tester identifier is a hidden user interface element and sent to the host 12 as described below. In another example, the tester's computer encrypts the data to authenticate the tester with host 12. After completing the form of user interface 600, the tester clicks on a submit button 626, which causes an onClick event handler to be called. The event handler retrieves the entered data from the user interface 600 and sends the data to host 12 via the internet using GET, POST, XMLHttpRequest or other methods.

As a result, processor 202 receives 44 the entered data, that is, the processor 202 receives multiple fault records through the user interface. Each of the multiple fault records comprises the fault description and is associated with one of the multiple tester identifiers of the team record determined earlier. This association with a tester identifier may be based on the tester identifier received from the tester's computer together with the data entered into user interface 600 or may be determined by processor 202 based on user credential of the tester, such as a secure token. Processor 202 may immediately make fault reports available for review by the Testing Director and or Client, in a user interface generated by processor 202 or by real time notifications or messaging, such as email or SMS.

Processor 202 then stores 45 each of the multiple fault records associated with the product or service and the associated tester identifier on a data store.

FIG. 7 illustrates a database 700 for storing multiple fault records. The database may be stored on data store 206 or on a separate storage device or on cloud storage. Processor 202 assigns a fault identifier 702 to each fault record and stores the tester identifier 704, a job identifier 706, the severity 708, the title 710, the description 712, the location 714, the bug types 716, the component 718, the form factor 720, the operating system 722, the web browser 724, version number 726, the device name 728 and the reference 730 as provided through user interface 600 in FIG. 6.

Once the testing period has expired, processor 202 determines a monetary value indicative of a monetary reward associated with each of the multiple tester identifiers based on the multiple fault records associated with that tester identifier and stored on database 700. In other words, processor 202 determines how much each tester will be paid for the identified faults. Processor 202 creates a pool of funds, which is determined on the customers budget when creating a challenge, such as a testing job. In other words, when the customer provides the characterising data of the job, the client also provide an indication of total funds available, that is, the budget. In one example, the cost to the client is higher than the budget, that is the pool of cash, because the operator of host 12 also charges for providing the testing infrastructure.

Based on the client's budget processor 202 determines the quality of testers which the client may choose. Processor 202 then stores an indication of the amount of funds in the pool of cash associate with the selected team as an incentive. The value is determined based on the quality of the testers. Processor 202 determines how this pool of cash is distributed to each tester based on their individual performance during a test cycle (challenge) as stored on database 700. Processor 202 ranks the testers against the top performing tester in the team and determines their payout accordingly. Processor 202 communicates the total amount in the pool of cash to the testers as well as the number of testers. As a result, it is transparent to each tester what is the earning potential for a particular testing job.

The present disclosure provides a means for utilising contingent workforces to identify and manage faults in computer software and other products and services that provides increased incentives to the participants to participate. In most cases the top performers have a better chance of earning more. Further, when using the proposed method testing more fun and engaging for the testers, which increases the performance and efficiency for the client.

As described above, each fault record comprises a fault classification 708, such as a fault severity. This allows processor 202 to determine the monetary reward based on the classification. In one example, there are four different severities of errors—Low, Normal, High, and Critical. Each severity of error is associated with a point score and each tester's points are tallied at the end of a cycle. For example:
Low 1pt,
Normal 2 pts,
High 3 pts, and
Critical 4 pts.

Once the testing is completed, processor may also update the reputation scores, that is skill levels 506 in FIG. 5. For every completed project each tester receives points. Processor 202 sums these points and compare them with the best result in the challenge using the following formula:

$$\frac{{p}_{i}}{{p}_{b}} * 10 ,$$

where pᵢ is the sum of points which user i collected in the project and p_{b} is the sum of points which the best tester collected in the project.

When determining the global score, processor 202 takes the average of all scores which user obtained in the projects. The current score compares the tester with their competitors in project. As a result, the best tester gets score 10. Processor 202 may round the numbers to one decimal place. Processor 202 then groups the testers into the category based on the score according to:
0-1.0: Newbie;
1.01-6: Adventurer:
6.01-8: Explorer; and
8.01-10: Elite.
   By re-calculating the score after each project the testers can rise of fall in their classification, which motivates the testers to perform well.

Processor 202 may determine the payout amount according to the following formula:

$$\frac{{p}_{i}}{{p}_{a}} * B$$

where pᵢ is the sum of points which user i collected in the project, pₐ is the sum of all points all testers collected in the project and B is the project's bounty, that is, price pool or total available funds to the testers. Processor 202 may round the values, so if the result of above formula is, for example, $123.3333 . . . , then user gets $123. If after the calculation some money is left (in this case $0.33), processor 202 assigns this to the winner as a bonus.

This particular way of scoring and determining payouts means that testers get rewarded regardless of whether they were the first to identify a particular fault. This ensures that the time pressure to each tester is only caused by the time period for the challenge and not by the performance of the competing testers. Displaying the performance of the competing testers in a cycle motivates the testers to outperform their peers and produce a better performance.

Processor 202 may present a leaderboard for the entire community and a ladder for each project also referred to as job or challenge. Processor 202 may only show points of each tester in the ladder and leaderboard and not show each testers earnings but it may be possible to calculate. Processor 202 indicates to the individual testers how much they have earned but not what other testers have earned.

The testers are asked to choose a severity themselves when submitting an error, and a testing director 216 then verifies each ranking and makes changes before presenting the data to the client. As per above, depending on the total points each tester has accumulated, processor 202 determines their total payout amount from the pool which has been assigned to the team.

Referring back to FIG. 3, in step 37, processor 202 informs the member 15 of their test results and assigned any awards or recommendations based on their results, such as by generating a web-site displaying the awards achieved by each tester. In this regard, if the processor 202 has determined a particularly high score for the tester for any one or more tests that indicate that that tester has obtained selection in an elite team depending on their overall reputation score, processor 202 displays this information to the tester and presents an award or medal to represent this achievement.

In this regard, the member may send a request to processor 202 to include their results or awards conferred by the host 12 as part of their curriculum vitae or resume, which can be used to support their expertise in the field of testing should they seek employment in such a relevant field in the future. Processor 202 may indicate the awards or medals in the form of “badge icons” collected for various successes achieved by the member throughout their involvement with the host 12. As the host 12 provides an independent assessment of the skills of the member 15 based on test results, processor 202 assesses any awards or results obtained by the member against all others who may have completed the tests and as offer a benchmark of that member against their peers.

It will be appreciated that the method 30 as depicted in FIG. 3 may be used by companies or organisations as part of an ongoing assessment of the employees who may be employed as programmers or testers to test or identify faults in software generated in-house. For example, software development companies and IT departments may use the system and method of the present invention to quantify the skill set of employees or potential employment candidates with regard to software testing and their understanding of specific types of software applications. The test programs or applications could also be used as training and educational tools within computer and software related courses. In this regard, a company or organisation may direct their employees to undertake regular assessments at regular periods and as such, the company or organisation may also be informed of the test results in step 37.

It will be appreciated that the above method provides for a simple and effective means of evaluating and quantifying a skill set of software developers and testers. As a result of this method, the present invention is able to source a variety of members with software testing skills from any destination so as to develop a worldwide pool of software testers. From this pool, processor 202 generates one or more elite teams of members having specific skill sets for use by organisations or companies to test and evaluate their software applications prior to release, across a variety of specialties.

In this regard, returning to FIG. 1, the system 10 of the present invention provides the ability for companies or organisations to utilise this pool of talent by registering as part of the client user group 16 as a client 17. In this regard, individual companies or organisations are able to register with the host 12 as a client 17 through the host interface 11. Once a client 17 is registered with the host 12 the client is able to submit their software for testing in the form of a request for identifying faults comprising characterising data as described above.

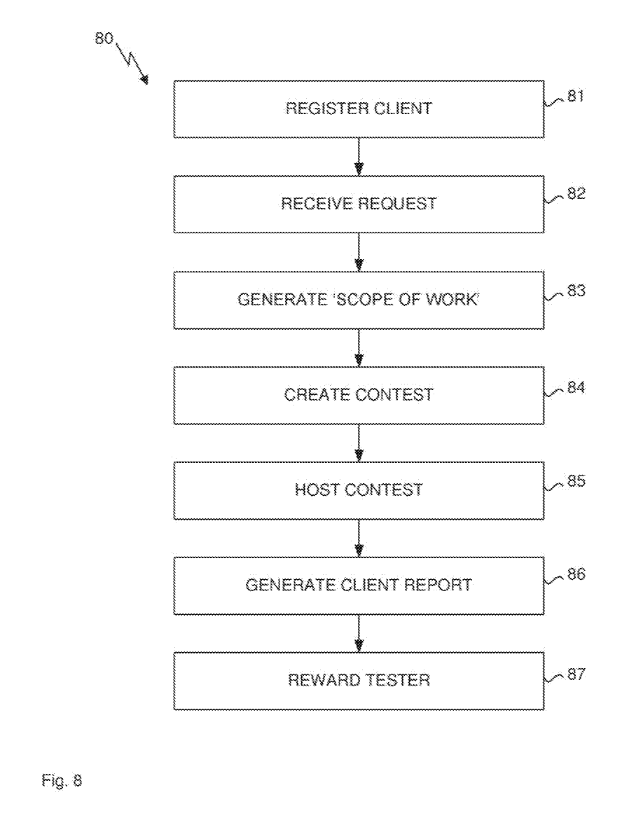

A method 80 for managing the process for receiving a request from a client 17 to test their software and undertaking the test is depicted in the flow chart of FIG. 8. As discussed above, in step 81 a company or organisation may register with the host 12 as a client. In order for a company or organisation to register as a client they may provide their relevant details and contact details whereby they will be registered as a registered client on the host server 13, that is, host server 13 receives the provided data, creates an account and stores the data associated with that new account. This can enable the history of use of the system by the client 17 to be recorded by host server 13 for future references.

Once a client 17 has registered with the host 12 the client is able to make a request to the host 12 for a test to be undertaken on all or a portion of a software application owned or otherwise controlled by the client 17. This request can be initiated by the client 17 accessing the host interface and making an appropriate project submission to the client by providing the necessary details of the project to be undertaken, that is, the client 17 sends a request comprising characterising data as described with reference to FIG. 4. In this regard, the host interface 11 may provide a request form to be completed online by the client 17 comprising a series of questions requiring completion by the client 17. As part of this step, the client 17 may submit, or make otherwise available, the version of the software application that they require to be tested. The type of information submitted as part of the request step 82 may include:
the areas or aspects of the software application require review/testing: e.g. security, usability; functionality:
the type of faults/bugs of interest:
the problems/types of problems require solving;
the time frame that the testing is to take:
cost of project;
access to the software application to be tested.

In step 83, the host 12, that is processor 202, reviews the project request made by the client and generates a scope of work summary setting out the scope of the project and seeking agreement of the terms and conditions of the project. This may include determining the team size of the members to be selected from the pool of members, the length of time required to complete the project and the form of the report to be generated. The scope of work may also provide cost options for the client 17 to consider in order to engage a higher level or more elite team of testers or to increase the size of the team working on the project. By way of example. Table 1, referred to below, provides an indication as to the various options that may be presented to a client showing the manner in which the project can vary depending upon the cost structure applied.

TABLE 1

| Program | Program 1 | | Program 2 | | Program 3 | | Program 4 | | Program 5 |
|---|---|---|---|---|---|---|---|---|---|
| No. of | 5 | | 10 | | 20 | | 30 | | To be |
| Testers | | | | | | | | | agreed |
| Contest | 48 | hours | 48 | hours | 72 | hours | 96 | hours | To be |
| Duration | | | | | | | | | agreed |
| Program | 3 | Days | 5 | days | 8 | Days | 10 | Days | To be |
| management | | | | | | | | | agreed |

| | | | | | |
|---|---|---|---|---|---|
| Total Cost | $10,000 | $20,000 | $40,000 | $60,000 | To be |
| | | | | | agreed |

As noted from Table 1, the client 17 may choose between a basic package, referred to above as the “Program 1” package, where the project will employ a team of 5 testers operating over a 48 hour test period with a 3 day turn around for supplying the report at a cost of around $10,000. Alternatively, should the client 17 prefer a more thorough testing regime for their software, they could request a “Program 4” package that includes a team of 30 testers operating over a 96 hour test period with a 10 day turn around to supply the report at a cost of around $60,000. Processor 202 receives the selection from client 17, such as through a graphical user interface generated by processor 202 and selects team members as described with reference to FIG. 5.

It will be appreciated that the above example is merely an illustration of the manner in which the various project options may be packaged for clients, and other alternatives are also envisaged. As part of this process the host 12 may request the client 17 to formally authorise the project and deposit the appropriate funds to facilitate commencement of the project.

Table 2 below provides another example for different tiers of testing, which may constitute the characterising data included in a request for testing a product or service.

| | | | |
|---|---|---|---|
| Lite | Standard | Plus | Professional |
| 2 Professional | 2 Professional | 5 Professional | Professional |
| Testers | Testers | Testers | Testers |
| Geographic Selection | I-land-Picked for Your | Hand-Picked for Your | Hand-Picked for Your |
| Criteria | Project | Project | Project |
| | Geographic Selection | Geographic Selection | Geographic Selection |
| | Criteria | Criteria | Criteria |
| | Competitor Checks | Competitor Checks | Competitor Checks |
| | | | Background Checks |
| | | | (optional) |
| Results | Results | Results | Results |
| Detailed Bug Reports | Detailed Bug Reports | Detailed Bug Reports | Detailed Bug Reports |
| | Advanced Curated | Advanced Curated | Advanced Curated |
| | Report | Report | Report |
| | Defect Videos | Defect Videos | Defect Videos |
| | Testing Director | Testing Director | Testing Director |
| | Challenge Design | Challenge Design | Challenge Design |
| | Real-Time Tester | Real-Time Tester | Real-Time Tester |
| | Support | Support | Support |
| | Product | Product | Product |
| | Recommendations | Recommendations | Recommendations |
| | | | Account Director |
| | | | Single Point of Contact |
| | | | Custom Account |
| | | | Management |
| | | | Standalone software tool |
| | | | Recruit your own testers |
| | | | Employees and |
| | | | customers |

Table 2 As shown in Table 2, processor 202 may receive a geographic selection criteria, which may include a selection of a time zone range or particular countries or continents. Processor 202 then selects only team members that satisfy these selection criteria Another selection criteria may be a particular device type or technologies as not all testers have all possible devices available. In other words, each tester has a tester profile with various different profile fields and client 17 can provide a criteria to be matched against the profile fields, such as geographic location, the type of experience they have, whether they have had probity and background checks or interviewed and endorsed by, or their sex or age.

In step 84, upon receipt of the funds to support the project and authorisation to proceed, the host 12 creates a Contest in accordance with the agreed Scope of Work. This would include determining the team size of the testers, the length of time of the Contest, the prize pool to be shared by testers and the manner in which points are to be awarded to the successful testers.

By way of example, should the client 17 select the “Program 1” package referred to in Table 1, the host would create the Contest in step 84 by inviting the top five members in the most relevant Elite team stored in the host server based on the tests conducted in the method of FIG. 2. Creating a Contest comprises storing data on data store 206 associated with a job number and other characterising data provided by the client 17. Processor 202 selects the top five members to form the Elite team of testers for the project. Processor 202 may send an email, for example, to each of the members and the email includes a briefing, such as a pdf document or link to a website, based upon the Scope of Work provided by the client 17 in step 83, setting out the purpose of the contest and the type of bugs/faults to be reported on as well as the duration of the test. Processor 202 also provides each member with an indication as to the pool of money on offer for the Contest. Each member would then be able to determine their earning potential before accepting the project, and if they wish to take part the member would respond to the host 12. Should an invitation to a Contest be rejected by the member, the host 12 would select the next highly ranked member and send an invitation to that member until all 5 spots on the team are filled.

In step 85, once all team members have committed to the Contest, each member is provided access to the software application to be tested, which may occur via the members being sent a link to the software application which may be hosted on the host server 13 or on a remote server 18. It is noted that in some applications, host 12 does not explicitly provide access to the product or service. In particular, in cases where the service is publicly available, such as when testing public transport or public amenities, the testers can simply access these services without being provided with access. However, providing access may comprises providing tickets or other items that allow the testers to access the service without incurring any further costs to access the service.

In a preferred form, access of the team members to the Client's software application for testing is controlled by way of a secure proxy. The use of a secure proxy is optional for customers to turn on for added security protection and measures. Processor 202 may query the proxy server to track and measure how much time the testers have been testing the asset and where they have been given their path. Processor 202 can essentially follow the testers on the map of the product or service and track time and bugs reported. The secure proxy server authenticates each member accessing the software application as they enter and access the software application. After the Contest is complete the secure proxy server removes the access. In one embodiment, prior to commencement of the Contest, the host creates credentials for each member of the elite tester team and generates a token for each member and sends an invitation to the member that includes the token and a login id. Each member then downloads the software application to be tested as, for example, an .ipa or .apk file on their computer device. The client includes the credentials in the associated URL and request data and to access the software app, the member enters their login id and token. The software application will then authenticate with the host's secure proxy at which stage the host passes the request data to the target client api. At the completion of the contest, the host deactivates the member and the proxy will stop all further requests.

It will be appreciated that such a system provides a degree of confidence and security to the client who may be concerned about unknowns accessing their software without approval and their software being shared with other parties during or after the testing process. By providing such a secure proxy layer security is assured. It will be appreciated that other security arrangements, such as the two factor authentication described above, may also be employed.

Once access to the software application is enabled, the Contest commences. Each of the invited members then competes to identify faults/bugs in the software in accordance with the project brief. During the Contest each member reports faults/bugs and the type of information required confirming the existence of the bug/fault. This may be achieved by screenshot and screen capture of the fault present in the software and means for identifying steps to reproduce the bug/fault and the location of the bug/fault, type and severity.

To facilitate collection of data during the Contest so as to generate the report for the client, processor 202 records the input actions of the tester (for example keystroke actions or mouse clicks) and processor 202 simultaneously captures video footage of what the tester sees as they compete in the Contest. Processor 202 records the time and date of each input action and inserts the input action into a timeline within the system. As the tester identifies bugs/faults within the application, processor 202 receives video footage of what the tester sees as they view the application as captured by the tester's client computer. This video footage is also fed into the system timeline with each frame of video being attributed to a specific time and date. Processor 202 then matches the video footage to the tester's data inputs (such as keystrokes or mouse commands). When a tester identifies a bug/fault within the application, they activate a control that alerts the system that a flaw has been located. Processor 202 records specific locations within the application, such as specific URLs and network addresses, GPS location, IP address or physical address at this time, when the bug/fault is found. The tester is then able to add a written description of the bug/fault as well as rate the severity of the bug/fault using an inbuilt rating system within the software interface. The system then records the location of the bug/fault, the data inputs that resulted in the bug/fault and a section of video demonstrating how the bug/fault appeared to the tester. While the above example relates to recording video data, it is noted that processor 202 may equally record audio data that may comprise a verbal recording of the description of the bug with or without recording the video data. When reference is made to video data herein, it is to be understood that audio data may be used instead.

In one example, processor 202 receives the fault records during the testing process and receives the complete video file after the testing process is completed. Since both the fault records and the video stream comprise the current time, processor 202 can tag sections of the video stream that relate to time stamps of the fault records.

During the duration of the contest, each tester is given access to data that states the number of bug/faults detected in real time, the type of bug/fault detected and the location of each flaw detected within the application being tested. Using the system, each tester can see how well they are performing against the group at any given time within the test period.

Once the Contest has been completed, a report is generated in step 86 which includes a collection of the automatically logged and video recorded location of the bug/fault along with the specific data inputs that resulted in the bug/fault. The Report compiles a list of all bugs/faults identified by all testers during the Contest. When the client selects a specific bug/fault within the list of bugs/faults, they are displayed together with the testers written description of the bug/fault as well as all relevant system information related to the test, such as the severity of the bug/fault along with other relevant information such as the browser or device the tester used to find the bug/fault. Along with this system information, the client is simultaneously taken to the specific location within the application where the bug/fault was detected. The specific section of video footage that recorded the bug/fault is also simultaneously displayed next to the application together with the application code, financial data, or geographic map, or graphical map depending on the tested product or service.

The video footage shows how the bug/fault appeared to the tester. This allows the Client to recreate the bug/fault within the application without the need to manually locate where the bug/fault occurred. All other information pertaining to the bug/faults is also collated from each of the testers, which is designed to make it faster and easier for the client's software developers to reproduce and correct identified software bugs/faults within a software application.

In another embodiment, the client can view the video footage of the bug/fault and the system will automatically open the uncompiled codebase of the application at the location where the bug/fault is present. When the Client moves to a new bug/fault and a new section of video footage is displayed, the system with automatically display the new section of application code where the next bug/fault appears.

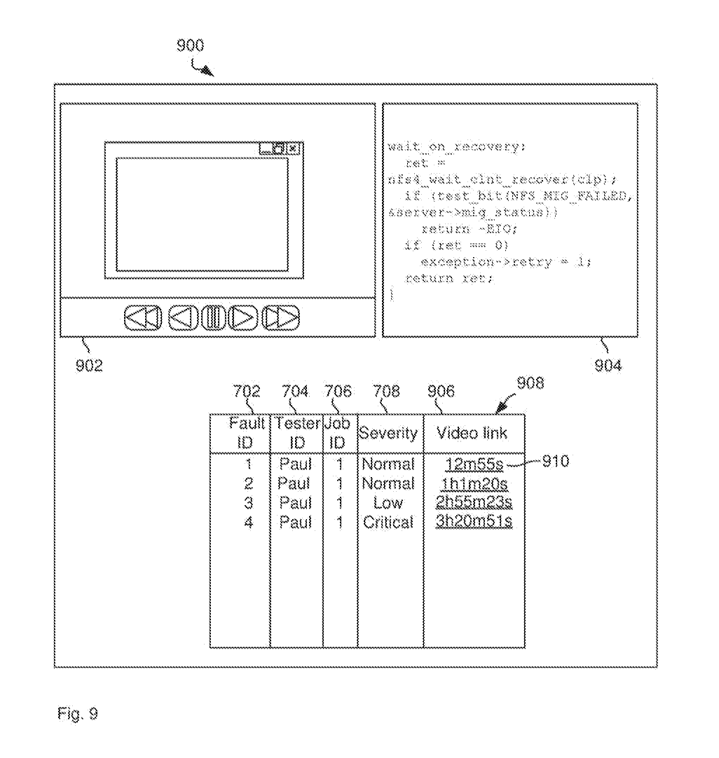

FIG. 9 illustrates a user interface 900 to assist the testing director 216. User interface 900 comprises a video panel 902, a source code panel 904 and a faults panel 906. The faults panel 906 displays a list of faults as shown in FIG. 7. Some columns are omitted for the sake of clear illustration. Each fault is associated with a particular segment in the source code and is also associated with a particular time in the video file. The table 906 comprises a further column for a video link 908. The testing director 216 can click on each link, such as example link 910. In response to detecting this onClick event, processor 202 sets the current playing position of the video player in video panel 902 to the respective position, which is 12 minutes 55 seconds in the example of link 910. Processor 202 further opens the part source code to which the fault relates and displays the source code in source code panel 904.

In step 87, following completion of the contest, processor 202 determines a reward for each of the testers/members of the team in accordance with the pre-established reward system. As previously discussed, each tester competes for a set prize pool, such as a cash prize pool, with the prize pool shared between all testers based on individual performances obtained during the Contest. Processor 202 determines the set prize pool from the Total project cost paid by the client, minus a percentage taken from the host. Processor 202 determines the largest proportional share of the set prize pool for the tester who scores most highly. On the other hand, processor 202 determines the lowest proportional share of the prize pool for lowest scoring tester. Processor 202 stores the determine values for rewards on data store 206 and may initiate payment to the testers, such as by automatically sending control messages to an accounting system.

The manner in which scores are calculated will be much as described previously in relation to the original assessment tests, with points allocated based on the severity of the bugs/faults identified. Testers that do not score at all during the test period will not receive any share of the prize pool. The system automatically records the tester's performance during the test and calculates the total earnings for the tester to be paid out on completion of the test.

Stored on data memory 206 may also be a set price associated with a particular type of bug/fault identified. By way of example, if a cash prize of $100 is associated with each serious bug/fault detected, then processor 202 determines that a tester who finds five serious bugs/faults will be awarded $500. If a prize of $10 is awarded for each minor bug/fault and the tester finds 3 minor bugs/faults, the processor 202 calculates a result of $30 associated with that tester.

In step 87, non-monetary rewards are also envisaged to be awarded to testers based on performance. In one embodiment, one or more badges may be awarded to testers based on performance in the Contest. Such badges may relate to the type of bugs/faults found by the tester, as well as badges for the number of bugs/faults detected during a given period of time, or any other deed considered worthy of note. To that end, processor 202 determines whether a tester has identified a threshold number of faults during the time period and stores an identifier of a badge associated with that tester in an achievements database and generates a display of a leader board recognition including digital rewards.

It will be appreciated that the disclosed system and method provide a means for evaluating and quantifying the skill set of software testers, incentivising the performance of software testers, allowing software testers to identify and report software flaws more rapidly and allow software developers to correct software flaws faster and more effectively than previously available methods.

Whilst the systems and methods have been described above in relation to the detection of faults/bugs present in a software application, it will be appreciated that the system and method of the present invention could be equally applied across a variety of different services including:
Ideation services—namely the creative process of generating, developing, and communicating new ideas:
Expertise-based services—namely tasks that are completed by online workers that are widely recognized as a reliable source of techniques or skills;
Micro-Tasks—namely short duration tasks completed by online workers, requiring no specialized knowledge or expertise:
Software services—include design, development, testing and user feedback gathering for programming code, software products and online applications.

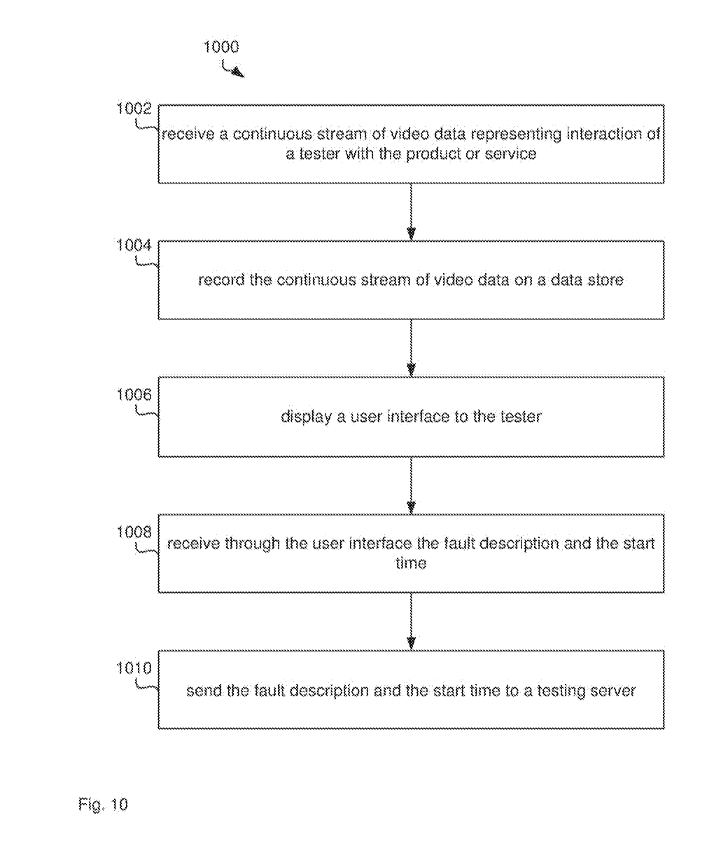

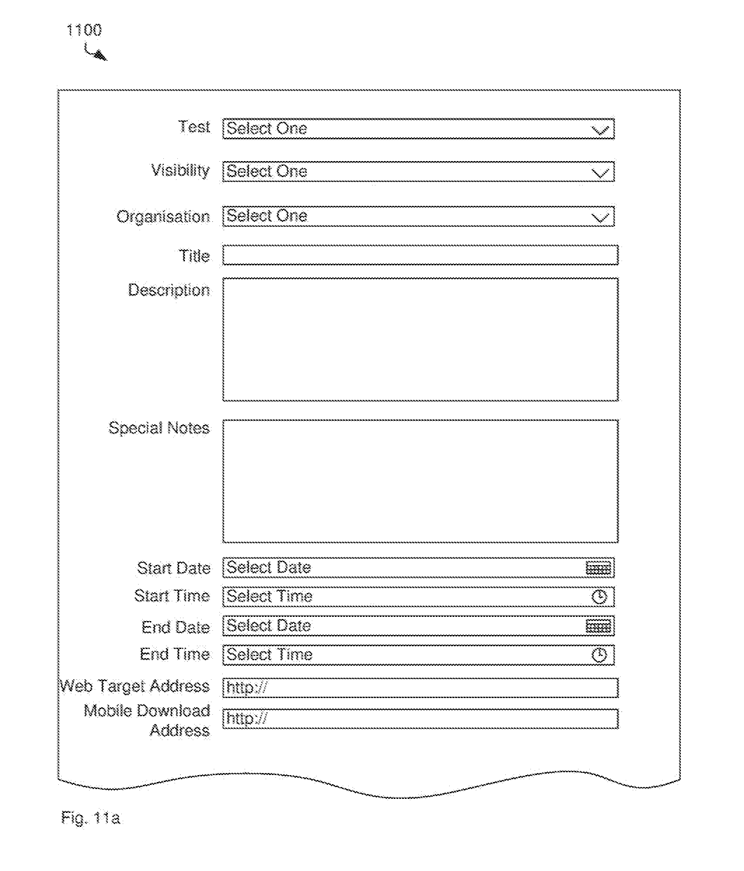

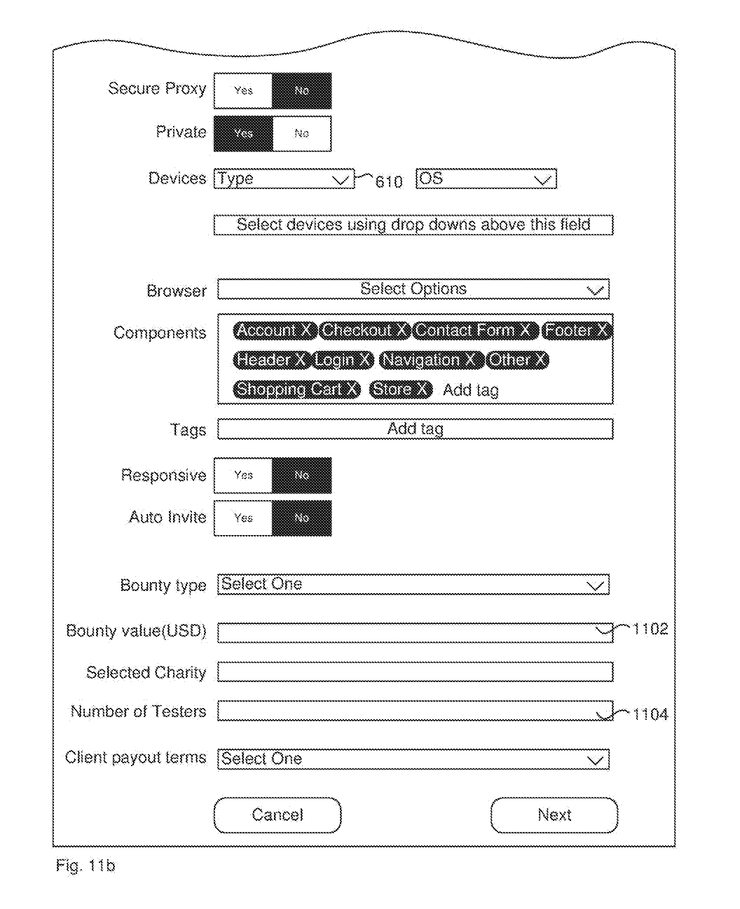

FIG. 10 illustrates a computer implemented method 1000 as performed by the tester's computer for reporting faults in a product or service. The tester's computer comprises components that are described with reference to FIG. 2 and therefore, reference numerals from FIG. 2 are now used to refer to components of the tester's computer.

Processor 202 receives using data port 208 a request for identifying faults in the product or service. The request comprising characterising data that characterises the request. For example, processor 202 receives information that a particular software is to be tested and can alert the tester of that job. Processor 202 also displays the total price pool for this testing job as described above.

Processor 202 displays to the tester an indication of a selection of multiple testers based on performance data associated with each of the multiple tester identifiers and based on the characterising data. This means the tester can review the list of testers or just the number of testers that have been selected for this job. As a result, the tester can judge the earning potential of this job and can decide whether to participate in this job or whether to look for another testing job.

The tester accepts to participate in this team and commences the testing of the product or service. During the testing, processor 202 receives 1002 a continuous stream of video data representing interaction of a tester with the product or service and records 1004 the continuous stream of video data on data store 206.

Once the tester identifies a fault and clicks on a “Fault Identified” button, processor 202 displays 1006 a reporting user interface to the tester. The reporting user interface comprises a first user control element allowing the tester to provide a fault description 606 and a second user control element allowing the tester to set a start time of a segment of the recorded video data such that the segment represents interaction of the tester with the product or service while the tester identifies the fault. The second user control element will be later described as element 1306 in FIG. 13.

Once the tester clicks on a “submit” button, processor 202 receives 1008 through the user interface the fault description and the start time and sends 1010 the fault description and the start time associated with the product or service and associated with the tester identifier to a testing server 12 is FIG. 1.

The data received through the user interface may be associated with a tester identifier associated with the tester by virtue of the tester having provided a password an username to log into the testing environment.

In one example, a single software application provides the functionalities of the reporting and the video interaction as will be described later with reference to FIGS. 13 and 14. In another example, when reporting faults each fault report is accompanied by a video recorded using Screencast-O-Matic (http://screencast-o-matic.com/).

When testing smartphone or tablet applications and recording videos of defects, testers can mirror the device and application they are testing by using third party tools such as one of the following:
Reflector for Mac, Windows, and Android http:/www.airsquirrels.com/reflector/download
Mirrorop for Windows http://www.mirrorop.com/
Airserver for Mac and Windows http://www.airserver.com/Mac
Mobizen for Android https://www.mobizen.com/?locale=en

When creating fault videos using Screencast-O-Matic, the web address URL of each video can be copied and pasted from Screencast-O-Matic into the report form and pasted under Reference. A tester may add more than one URL address per bug report.

FIGS. 11a and 11b illustrate a user interface 1100 to generate a request for identifying faults in the example of an online store being the product. User interface 1100 comprises input fields for providing a bounty value 1102 and for providing a number of testers 1104. These two values may be entered by a client and received by processor 202 as the characterising data of the request for identifying a fault in the online store.

In one example, user interface 1100 may comprise a control element to select to encrypt all bugs which are reported once they are submitted by a tester to the system 12. Only the client is provided with a unique key to be able to view them. This adds an extra layer of security to the process, and reduces the likely hood of a tester being able to share that data. Further, clients can choose to have their videos stored in our cloud or their own cloud.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Processor 202 may create software from the ground up which has defects built in. Testers compete over a set period of time to report back the defects they discover in that pre-built software as described above. Processor 202 may change the software on a regular basis to introduce new defects. The testers are then ranked against the top-performing tester, and can use those results to confirm their skills to a future or current employer.

Processor 202 may take the defects discovered during a cycle and build a range of automated test scripts based on those defects, which have been reported. This would help clients to build automated testing over time (rather doing manual testing), which will reduce their defects, but also allow for our testers to spend more of their time focusing on testing parts of the application and discovering more high value defects.

The disclosed system may embed tracking code and tools into their applications and provide heat mapping and user generated data which is automatically produced by testers while they are testing an application and working their way through testing a product. This may also include automatic generated exception reports created when a tester breaks the product they are testing, geo region, device and browser type, and heat mapping to determine where they spend most time.

Processor 202 may video record an entire testing session from each tester, and present that data to clients like a movie. Clients could click on each defect reported it provides the context of the defect and then takes the client directly to that point in time in the movie, which enables them to watch the video of the defect and better understand the problem. This also makes it easy to share the defects with other team members, as you have noted above.

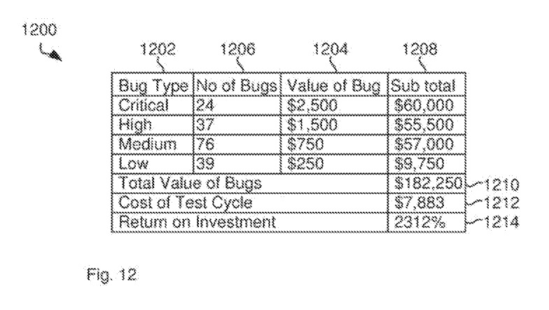

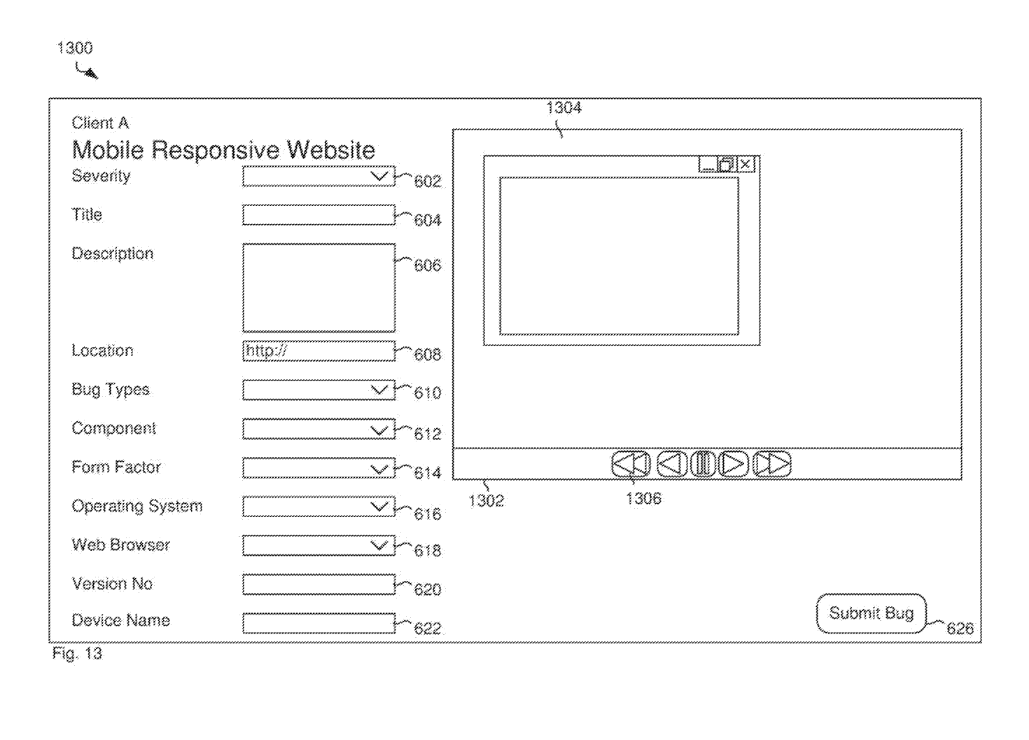

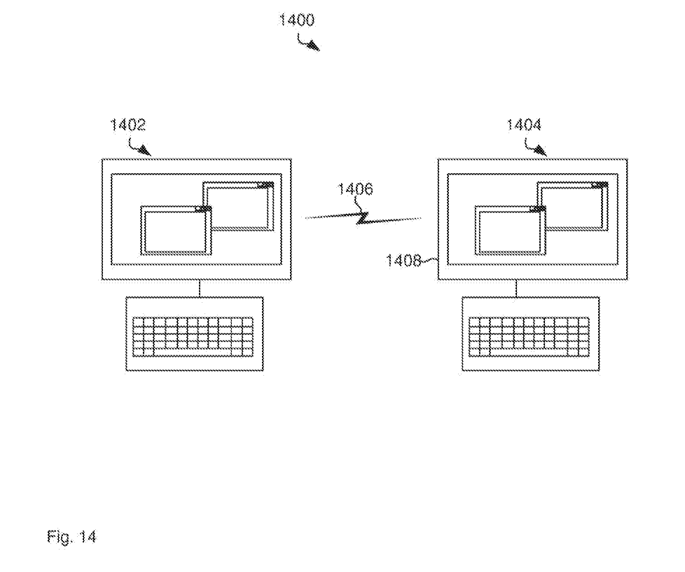

FIG. 12 illustrates a return on investment (ROI) model 1200. Processor 202 receives from the client through a further user interface for each bug type 1202 a value 1204 that reflects the cost to remediate a particular error, what stage the error is discovered (staging or production), the client size, and total number of different severities. In other words, prior to the testing session the client agrees to a financial value placed on each severity of bug. At the end of the testing process, processor 202 multiplies the number of identified bugs 1206 to determine a subtotal for each bug type 1208. Based on a total value of bugs 1210 and the cost of the test process 1212 processor 202 then determines a ROI value 1214.

Processor 202 presents back the results in terms valued and savings or revenue delivered to clients derived by the performance of the team which helps save time repairing the faults for clients. At the end of each test cycle processor 202 creates an ROI model 1200. The client can input the cost of each severity. Processor 202 can also add revenue values to the ROI model to not only conduct a cost saving analysis, by also show an estimate of how much more revenue a company may be able to make after running a team and releasing better quality products. Another way cost saving can be determined can be by the cost for a call centre to support users. It can be measured based on the severity of the error reported, how many calls they receive per particular error, and the cost per call to support each user. When a client reduces the amount of defects in production, this also means these call centres spend more time selling new products and services, rather than support users, which increases their revenue.

Rather than a client providing a product they believe is of good standing, processor 202 may build software from the ground up which has various severity levels of defects already implemented into the product or service, with varying degrees of severity or difficulty. Individual testers are given a timeframe in which they can test the product or service, and compete over a set period of time to report back the defects they discover in that pre-built software. Everyone is competing against the top-performing tester, and scored using the same point system as the current model. Processor 202 also generates a leader board ranking and a score. Processor 202 may change the product or service on a regular basis to introduce new defects. The testers are then ranked against the top-performing tester, and can use those results to confirm their skills to a future or current employer.

The disclosed method and system are used to drive the performance of the team. Processor 202 may build a physical or virtual map of the product or service that is being tested either by embedding tracking code inside a product and tracking the testers, or importing a visual representation of the product or service we are testing. Processor 202 tracks testers as they move around a product or service based on various methods depending on what we are testing but can include location, URLs, video or eye tracking. As they get to certain areas of a product or service, we can show them where they have been, which parts of the product or service they have tested, and how they compare to the performance of other testers which have testers those areas of a product or service based on what has been reported. Real time alerts can be generated to direct testers to untested areas of a product or service, or notify a testing director to an area of the product or service that requires more testing. Testers and administrators can view a map in real time, and use the map as a way to navigate the product or service.

The actions of each tester are individually recorded by video and when a tester reports a defect it time stamps the video where the defect was recorded. When a fault is identified, the system records the location of the fault like a time stamp, for example collecting the URL or web address. For real world testing the geographic location might be used and the video could be taken by using Google glasses, and map these defects based on their physical location using geo mapping. Clients are presented with a list of defects in a timeline or a play list (like a list of songs in iTunes) and when they click each defect it takes the customer directly to the point in time in the video so they can easily play the video of the defect and review the error in significantly less time. Processor 202 also show them the address of the error in the application, and also displays the area in the code where the error has occurred making it easier to review and remediate. This also makes it easy to share the defects with other team members.

FIG. 13 illustrates another user interface 1300 that allows the tester to submit a bug together with a captured video. While some of the above examples are integrating third party software modules, the example of FIG. 13 may be implemented as a monolithic software reporting application that the testers can download and install on their computers, which has a similar structure to computer system 200 in FIG. 2 and the reporting application is installed on program memory 204. In some scenarios it may be difficult to record screen capture videos on the same platform as the testing is performed, for example, when testing under different varieties of technology platforms, or testing products or services in the real world, other technologies may be used such as a Go-Pro camera or Google glasses.

FIG. 14 illustrates a computer network 1400 to address this issue. The tester tests the product or service on testing computer system 1402, which mirrors the screen to a reporting computer system 1404 via a wireless connection 1406, such as using a Bluetooth or Wifi adapter as an output port to send video data. The reporting application generating user interface 1300 is installed on program memory of reporting computer 1404 and is executed by a processor of the reporting computer 1404. The reporting computer comprises an input port, such as a Wifi or Bluetooth adapter, to receive from the first computer system a continuous stream of video data representing interaction of a tester with the product or service. The reporting computer 1404 comprises a datastore to store video data and the reporting software continuously receives and records the mirrored video on the datastore, such as a hard disk or cloud storage.

When a tester identifies a fault the tester activates a control button “Report Bug” on either the testing platform 1402 or the reporting platform 1404, which causes the reporting platform to generate user interface 1300 and stop the continuous recording of the mirrored screen of testing platform 1402.

The processor of reporting computer 1404 generates user interface 1300, which is displayed on a display device 1408. The user interface 1300 comprises the input elements as described with reference to FIG. 6. In addition, user interface 1300 comprises a video panel 1302, which shows a video image of the screen of the testing platform 1402. The tester can user control element 1306 to rewind the video to the start of the faulty behaviour of the product. In other words, the user control element 1306 allows the tester to set a start time of a segment of the recorded video data such that the segment represents interaction of the tester with the product or service while the tester identifies the fault. This way the tester can set the time to indicate which part of the video is relevant for identifying and fixing the fault. As a result of the continuous recording of video, the tester does not need to replicate the fault for reporting purposes, which can be difficult for some faults.

Reporting computer 1404 comprises a user input port, such as a data port of a processor that is controlled by an event handler called by the user interface 1300, such as by triggering an interrupt, to read the values from user interface 300 and provide the fault description, the start time and other values to the processor.

Testing computer 1404 further comprises an output port, such as a LAN or other network interface connected to the internet. When the tester clicks the “Submit Bug” button 626, the processor of the reporting computer 1404 sends the fault description and the start time associated with the product or service and associated with the tester identifier to a testing server 12, such as by sending an XML file or message with those values included. The reporting computer 1404 may further store the time when the video recording was stopped and send this time to the server 12 as the end time of the segment that shows the identification of this particular fault. This way the tester can perform a series of actions to provoke the fault without being concerned about the reporting process. The tester can then activate the reporting process by clicking “fault identified” and rewind the video to the most appropriate position to show the fault.

It is noted that different combinations of user interfaces may be possible to allow the tester to submit a fault, such as
only submit form 600;
submit form and video as in FIG. 1300: or
submit form and video as in FIG. 1300 together with a code window similar to code window 904 in FIG. 9.

It is further noted that when using the reporting software program the tester can submit the fault with a video reference without pasting a reference URL into the report form as described with reference to FIG. 6. The reporting software may store the video data on a cloud storage server that allows accessing the video data through an URL, which is one single URL for the entire video recording of the entire testing process, and or multiple URL's for each reported defect. When the reporting computer 1404 sends the start time to the server 12 the reporting computer may also send the URL to the video. However, the reporting computer 1404 may send the video URL at the beginning or the end of the entire testing process since the video URL is not specific to identified faults.

It is noted the proposed systems and methods are equally applicable to Content testing, user testing, accessibility testing, user experience testing, functional testing, seo testing, cross browser testing, beta testing, usability testing, security testing, manual testing, software testing, load testing, black-box testing, user acceptance testing and performance testing.

Although the above examples are described with reference to identifying faults, the process of identifying a team based on performance data and the project characterisation may equally be applied to select a team of searchers and receive search result records via a user interface as described above.

The following non-limiting statements are provided in relation to the above disclosure:

Statement 1: A method for evaluating and quantifying a skill set of software testers comprising:
receiving an application for evaluation from a software tester;
configuring at least one assessment test for completion by the software tester, the at least one assessment test configured to test a specific skill of the software tester;
conducting said at least one assessment test;
collecting results from said software test for the at least one assessment test; quantifying said results based on a number of faults detected in the at least one assessment test;
ranking said software tester against a pool of said software testers.

Statement 2: A method for identifying faults in a software application comprising:
receiving the software application for assessment;
identifying a team of software testers based on the ranking obtained in the method of statement 1;
providing access of said team of software testers to said software application for assessing said software application for the presence of faults therein;
recording an ability of the team of software testers to identify faults present in the software application;
rewarding each software tester in the team of software testers based on that software testers ability to identify faults present within the software application.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

1. A computer implemented method for identifying faults in a product or service, the method comprising:
receiving a request for identifying faults in the product or service, the request comprising characterising data that characterises the request;
selecting multiple tester identifiers based on performance data associated with each of the multiple tester identifiers and based on the characterising data to generate a team record, each tester identifier being associated with a tester;
generating a user interface associated with each of the multiple tester identifiers of the team record, the user interface comprising a user control element allowing a tester to provide a fault description;
receiving through the user interface multiple fault records, each of the multiple fault records comprising the fault description and being associated with one of the multiple tester identifiers of the team record; and
storing each of the multiple fault records associated with the product or service and the associated tester identifier on a data store.

2. The method of claim 1, wherein the product or service is one or more of:
source code;
a financial report;
a technical specification;
user interface;
software application; and
a food item.

3. The method of claim 1, further comprising determining a monetary value indicative of a monetary reward associated with each of the multiple tester identifiers based on the multiple fault records associated with that tester identifier.

4. The method of claim 3, wherein receiving the multiple fault records comprises receiving a fault classification associated with each of the multiple fault records and determining the monetary value is based on the fault classification.

5. The method of claim 1, wherein the characterising data comprises an indication of the total funds available for testing the product and determining the monetary value is based on the total funds available.

6. The method of claim 1, further comprising:
receiving input data indicative of a monetary value of each identified fault,
wherein determining the monetary value indicative of a monetary reward associated with each of the multiple tester identifiers comprises determining the monetary value indicative of a monetary reward associated with each of the multiple tester identifiers based on the monetary value of each identified fault.

7. The method of claim 1, further comprising updating the performance data associated with one of the multiple tester identifiers based on the fault record associated with that one of the multiple tester identifiers.

8. The method of claim 1, further comprising:
generating a user interface associated with each of the multiple tester identifiers, the user interface comprising a user control element allowing a tester to provide a fault description of an assessment product; and
determining the performance data by comparing the fault description to fault data stored on a data store associated with the assessment product.

9. The method of claim 1, wherein receiving each of the multiple fault records comprises receiving video data visualising that fault record.

10. The method of claim 1, wherein receiving each of the multiple fault records comprises receiving audio data describing that fault record.

11. The method of claim 1, further comprising generating a user interface comprising a graphical indication of the performance data associated with multiple tester identifiers.

12. The method of claim 11, wherein the graphical indication of the performance data comprises an icon located in relation to one of the multiple tester identifiers and indicative of an achievement by that tester in identifying faults.

13. The method of claim 1, wherein the characterising data comprises an indication of a performance threshold and selecting the multiple tester identifiers comprises selecting the multiple tester identifiers such that the performance data associated with the multiple tester identifiers is greater or equal than the performance threshold.

14. The method of claim 1, wherein receiving the request comprises receiving input data indicative of a period of time for identifying faults and indicative of total funds for identifying faults.

15. The method of claim 1, further comprising operating a secure proxy server, wherein receiving the request comprises receiving the request through the secure proxy server and receiving the multiple fault records comprises receiving the multiple fault records through the secure proxy server.

16. The method of claim 1, wherein selection multiple testers comprises randomly adding tester identifiers associated with performance data below a performance threshold based on the characterising data to the team record.

17. Software that, when executed by a computer, causes the computer to perform the method of claim 1.

18. A computer system for identifying faults in a product or service, the computer system comprising:
an input port;
a processor to
receive using the input port a request for identifying faults in the product or service, the request comprising characterising data that characterises the request,
select multiple tester identifiers based on performance data associated with each of the multiple tester identifiers and based on the characterising data to generate a team record, each tester identifier being associated with a tester,
generate a user interface associated with each of the multiple tester identifiers of the team record, the user interface comprising a user control element allowing a tester to provide a fault description, and
receive using the input port through the user interface multiple fault records, each of the multiple fault records comprising the fault description and being associated with one of the multiple tester identifiers of the team record; and
a data store to store each of the multiple fault records associated with the product or service and the associated tester identifier.

19-32. (canceled)
